(19) United States
(12) Patent Application Publication
(10) Pub. No.: US 2024/0220576 A1
(43) Pub. Date: Jul. 4, 2024

(54) DEEP LEARNING TEXT GENERATION FOR UPGRADING MACHINE LEARNING SYSTEMS

(71) Applicant: International Business Machines Corporation, Armonk, NY (US)

(72) Inventors: Li Juan Gao, Xi'an (CN); Yong Wang, Xi'an (CN); Zhong Fang Yuan, Xi'an (CN); Liu Yao He, Beijing (CN); Yuan Yuan Ding, Shanghai (CN); Yu Pan, Shanghai (CN); Jing Zhang, Shanghai (CN)

(21) Appl. No.: 18/092,190

(22) Filed: Dec. 30, 2022

(51) Int. Cl. G06F 18/214; G06F 18/22; G06N 3/094

(52) U.S. Cl. CPC G06F 18/214; G06F 18/22; G06N 3/094

(57) ABSTRACT

Prompt learning is performed, using a prompt encoder, on an input data set to generate a revised text pattern. The revised text pattern is processed, using a text generative adversarial network, based on an existing data set to generate a fused data set and a machine learning system is updated with the fused data set.

### BACKGROUND

The present invention relates generally to the electrical, electronic and computer arts and, more particularly, to expert systems and machine learning.

Over time, during the use of machine learning systems that incorporate expert experience, human expertise and experience are often gained and subsequently lost over time. Expert knowledge and experience are extremely important in data processing tasks and in maintaining the technical capabilities of expert systems and machine learning systems. Once expertise is lost, many expert systems and machine learning systems become black boxes, i.e., human expert knowledge of their functioning is lost, making it difficult to perform data processing or migrate to new data sets.

In this context, converting the experience and knowledge of experts to data for incorporation into the machine learning systems can be regarded as perfectly designed feature engineering or a perfectly designed expert system. The feature engineering is usually explicable and, in some situations, has a background which, while being very valuable, often takes an extensive number of human resources and experience to summarize and makes the feature engineering difficult to maintain. As an expert system or machine learning system is used in practice and new data is continuously generated, it is often troublesome to add new data sets to existing data sets and to re-do the feature engineering based on the new expert knowledge and experience (which otherwise may be lost over time). Meanwhile, the model needs to be retrained based on the new expert knowledge and the effectiveness of the model cannot be guaranteed. A key issue, therefore, is how to transfer new data into an existing data set; that is, how to change the distribution of the new data set based on the old data set, and then apply the transformed new data set directly to the existing system to obtain accurate prediction results.

### BRIEF SUMMARY

Principles of the invention provide techniques for deep learning text generation for upgrading machine learning systems. In one aspect, an exemplary method includes the operations of performing, using a prompt encoder, prompt learning on an input data set to generate a revised text pattern; processing, using a text generative adversarial network, the revised text pattern based on an existing data set to generate a fused data set; and updating a machine learning system with the fused data set.

In one aspect, a non-transitory computer readable medium comprises computer executable instructions which when executed by a computer cause the computer to perform a method of performing, using a prompt encoder, prompt learning on an input data set to generate a revised text pattern; processing, using a text generative adversarial network, the revised text pattern based on an existing data set to generate a fused data set; and updating a machine learning system with the fused data set.

In one aspect, an apparatus comprises a memory and at least one processor, coupled to the memory, and operative to perform operations comprising performing, using a prompt encoder, prompt learning on an input data set to generate a revised text pattern; processing, using a text generative adversarial network, the revised text pattern based on an existing data set to generate a fused data set; and updating a machine learning system with the fused data set.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improving the technological process of a computerized machine learning system with expert experience by adapting an existing computerized system to a new data set, without the need for feature engineering performed by a human subject matter expert;
data transformation mapping systems and techniques for expert systems and machine learning systems based on a prompt encoder and a text generative adversarial network;
the upgrading of existing systems and the incorporation of accumulated data while only requiring training on a small amount of data to achieve an effective model;
elimination of the need to maintain an expert system and, once a corresponding model is trained, changes to the data distribution can be directly applied to the original model;
improved data migration mapping accuracy;
reduced dependence on experts; and
improved work efficiency.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates a conventional common pipeline of an expert system, convenient for illustrating aspects of an example embodiment;

FIG. 2 illustrates an improved portion for the common pipeline where the detailed process of feature engineering can be bypassed during upgrading of the machine learning system, in accordance with an example embodiment;

FIG. 3 illustrates a workflow for a data transformation mapping system that generates the fused data set which has the original meaning of a new data set incorporated with the style of the existing data set, in accordance with an example embodiment;

FIG. 4 illustrates a workflow of the prompt-based pre-trained language model, in accordance with an example embodiment;

FIG. 5 illustrates a block diagram of the text generative adversarial network (textGAN) for performing text style fine tuning, in accordance with an example embodiment; and

FIG. 6 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

In general, techniques are provided for using deep learning text generation techniques to upgrade expert systems, existing machine learning systems, and the like. In one example embodiment, deep learning is used to transform a new data set based on an existing data set that belongs to a given expert or machine learning system. In one example embodiment, an existing system, which potentially incorporates a large amount of complex and special feature engineering capabilities, is adapted to be reused with a new data set without requiring additional feature engineering. This, for example, allows expert systems to be technically adapted to address new requirements.

In one example embodiment, a mapping system and methods map the distribution of a new data set into an existing data set, preserving the original meaning of the new data set while utilizing the style of the existing data set. The data transformation mapping system is based on prompt learning and a text generative adversarial network (textGAN). Here, the prompt learning mechanism matches the new data with the existing data using a user-defined or auto-generated template, which can change the new text data while maintaining its original meaning. For example, consider the template: “This product is really YYDS, means, This product is XXX.” User-defined and auto-generated templates can be employed. Knowledge from language models can be elicited with automatically generated prompts. The textGAN incorporates the data style of the existing text onto the new transformed text data. Using these two techniques, a different text data set is generated which has the original meaning of the new data set but incorporated with the style of the existing data set. The expert system or machine learning system can then be used directly with the new data set.

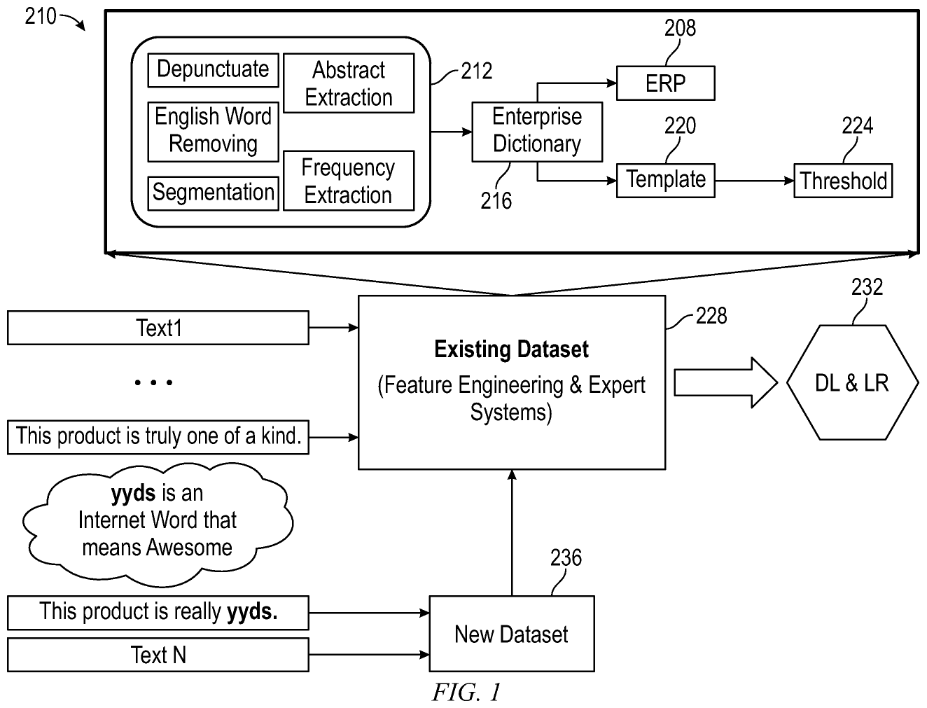

FIG. 1 illustrates a conventional common pipeline 210 of an expert system. The skilled artisan will be familiar with elements 212, the enterprise dictionary 216, the enterprise resource planning system 208, the template 220, and the threshold 224. The enterprise resource planning system 208 relies on the enterprise dictionary 216 for performing planning tasks for an enterprise. The common pipeline 210 initially utilizes an existing data set 228. At some point in time, a new data set 236 becomes available and is adapted with the style of the existing data set 228 to enable the common pipeline 210 to utilize the feature engineering of the new data set 236. The new data set 236 is essentially directly added to the existing data set 228, the fused dataset 232 is processed, and the model is retrained according to the feature engineering design of the fused data set 232 (based on deep learning (DL) and logistic regression (LR)). Such conventional systems require complex feature engineering and are difficult to maintain.

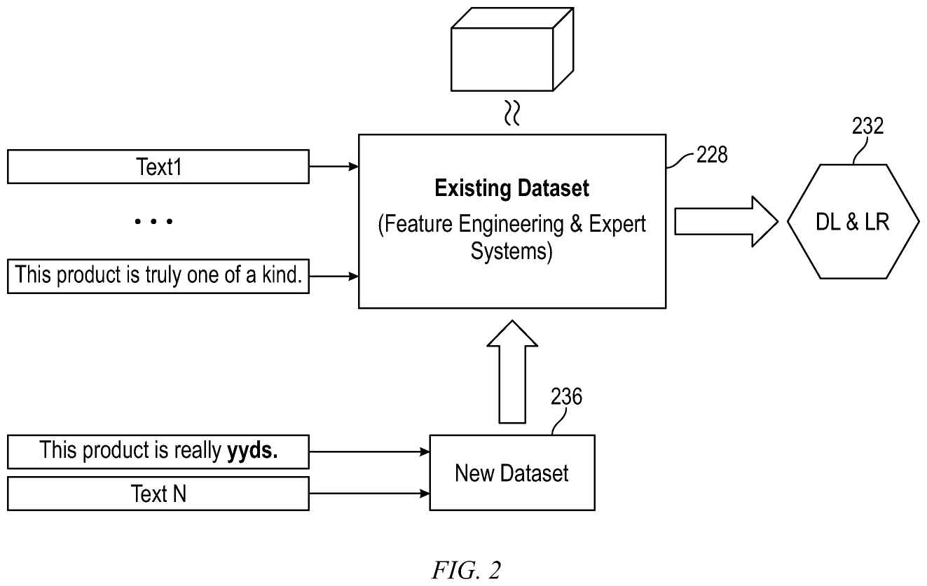

FIG. 2 illustrates an improved portion for the common pipeline 210 where the detail process of feature engineering can be bypassed during upgrading of the machine learning system 210, in accordance with an example embodiment. The treatment of the feature engineering as an unrequired process eliminates the need to know the design process of the feature engineering and eliminates the need to maintain the feature engineering once data is generated. The new data set 236 is added to the existing data set 228 to generate a fused data set 232 that maintains the original meaning of the new data set 236 while incorporating the style of the existing data set 228.

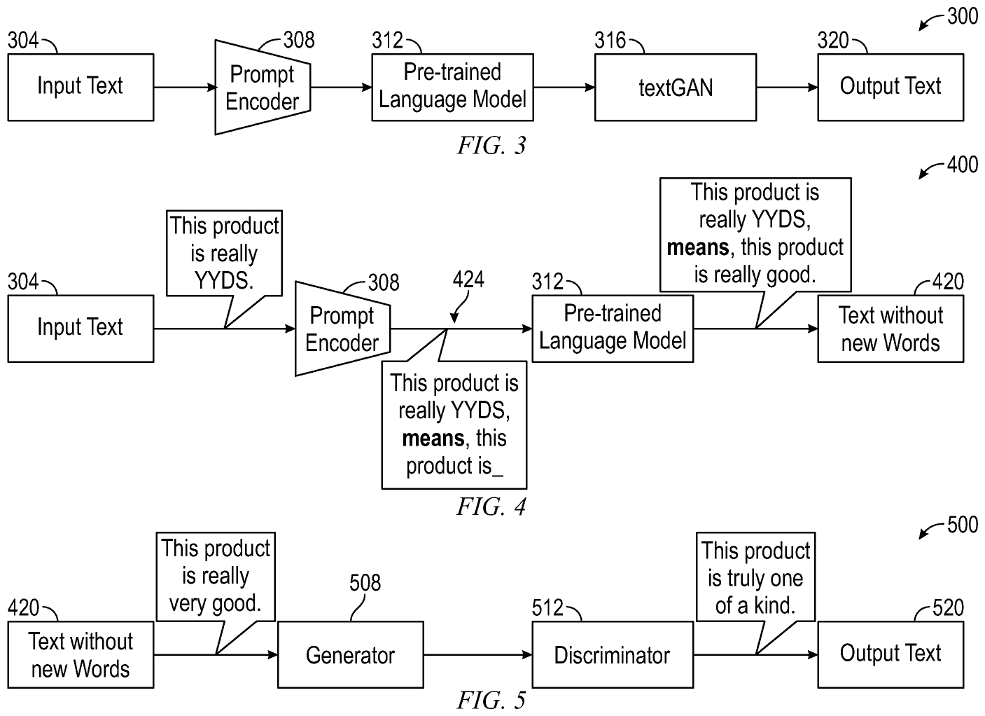

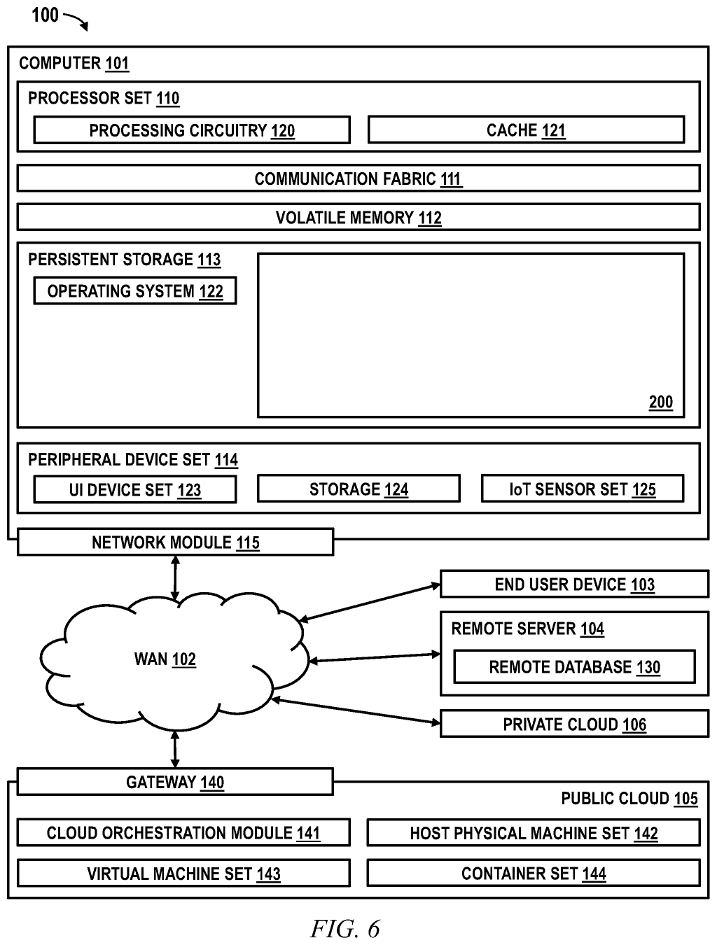

FIG. 3 illustrates a workflow for a data transformation mapping system 300 that generates the fused data set 232 which has the original meaning of a new data set 236 incorporated with the style of the existing data set 228, in accordance with an example embodiment. The data transformation mapping system 300 is based on a prompt encoder 308 and a text generative adversarial network (textGAN) 316. In one example embodiment, input text 304, such as the new dataset 236, is processed by the prompt encoder 308 to produce the escaped new data (for example, words with the same meaning and style as the input text 304). The textGAN 316 is then used to fine-tune the text style of the escaped new data to generate the final output text 320 (which is based on the style of the existing data set 228). In one or more embodiments, the new nouns in the new data are input into the pre-training model through a prompt to get the new data after escaping. The new nouns can be the input of the pre-trained language model 312. In one or more embodiments, the “new data after escaping” is an output of the pre-trained language model 312.

FIG. 4 illustrates a workflow 400 of the prompt-based pre-trained language model 312, in accordance with an example embodiment. FIG. 4 in essence provides a more detailed description of FIG. 3. The initial mapping for data transformation performed by the data transformation mapping system 300 based on prompt techniques includes the following steps:
constructing a prompt encoder 308 that constructs a revised text pattern 424 according to the new words in the new text data set, so as to help the pre-trained language model 312 be more “obedient” to ascertain the specific meaning of the new words (for example, the prompt encoder 308 is constructed to employ a prompt template as described above to encode the sentence: as in FIG. 4, the input is “This product is really YYDS,” and the output is 424).
constructing the revised text pattern 424; and
inputting the prompt-generated data (such as the revised text pattern 424) into the pre-trained language model 312. The corresponding meanings of the new words can then be obtained based on the output 420 of the pre-trained language model 312. The output 420 is essentially the revised text pattern 424 without the new words.

FIG. 5 illustrates a block diagram 500 of the textGAN 316 for performing text style fine tuning, in accordance with an example embodiment. The textGAN 316 includes a generator 508 and a discriminator 512. The input to the textGAN 316 is the output 420 (the data after the new text is escaped and the new words are removed) generated by the pre-trained language model 312. The escaped new data (i.e., data converted to a word with the same meaning and style) is fine-tuned to obtain the final output text 520 which is similar to the style of the existing data set 228. The generator 508 is used to generate the escaped text in natural language and the generated results are judged by the discriminator 512 to generate the final output text 520.

As will be appreciated by the skilled artisan, the ERP 208 may be a commercially available software program that organizations use to manage day-to-day business activities such as accounting, procurement, project management, risk management and compliance, and supply chain operations. The datasets depicted in the figures can be stored using known file structures or other known data structures.

A generative adversarial network (GAN) is a class of machine learning frameworks wherein two neural networks contest with each other in the form of a zero-sum game, where one agent's gain is another agent's loss; a GAN can be implemented in software running on a general purpose computer, on specialized higher-power processors such as graphics processing units, or GPUs, or with the use of hardware accelerators.

Prompt-learning is the latest paradigm to adapt pre-trained language models (PLMs) to downstream natural language processing (NLP) tasks. Prompt learning modifies the input text with a textual template and directly uses the PLMs to conduct pre-trained tasks. The prompt encoder 308 is a process for performing prompt learning (modifying the input text with a textual template to generate new data that is recognized by the pre-trained language model 312 (PLM)). The PLM then performs specific tasks in that language. The pre-trained language model 312 is first fed a large amount of unannotated data (for example, the complete dump from a well-known online free encyclopedia). This lets the pre-trained language model 312 learn the usage of various words and how the language is written in general. The model is then transferred to an NLP task where it is fed another smaller task-specific dataset, which is used to fine tune and create the final model capable of performing the aforementioned task.

The generator 508 and discriminator 512 are part of a Generative Adversarial Network (GAN). The GAN frames a problem as a supervised learning problem with two sub-models: the generator model that is trained to generate new examples, and the discriminator model that tries to classify examples as either real (from the domain) or fake (computer generated). The two models are trained together in a zero-sum, adversarial game until the discriminator model is fooled; for example, only about half the time, meaning the generator model is generating plausible examples.

Given the discussion thus far, it will be appreciated that, in general terms, an exemplary method, according to an aspect of the invention, includes the operations of performing, using a prompt encoder 308, prompt learning on an input data set 236 to generate a revised text pattern 424; processing, using a text generative adversarial network 316, the revised text pattern 424 based on an existing data set 228 to generate a fused data set 232; and updating a machine learning system 210 with the fused data set 232. For the avoidance of doubt, one or more embodiments do not concern a new sentence pattern, but rather facilitate understanding new words in the new text/new input data.

In one aspect, a non-transitory computer readable medium comprises computer executable instructions which when executed by a computer cause the computer to perform the method of performing, using a prompt encoder 308, prompt learning on an input data set 236 to generate a revised text pattern 424; processing, using a text generative adversarial network 316, the revised text pattern 424 based on an existing data set 228 to generate a fused data set 232; and updating a machine learning system 210 with the fused data set 232.

In one aspect, an apparatus comprises a memory and at least one processor, coupled to the memory, and operative to perform operations comprising performing, using a prompt encoder 308, prompt learning on an input data set 236 to generate a revised text pattern 424; processing, using a text generative adversarial network 316, the revised text pattern 424 based on an existing data set 228 to generate a fused data set 232; and updating a machine learning system 210 with the fused data set 232.

In one example embodiment, the performing and processing operations further comprise preserving an original meaning of the input data set 236 while utilizing a style of the existing data set 228.

In one example embodiment, the performance of the prompt learning matches the input data set 236 with the existing data set 228 using a user-defined or auto-generated template (generally, the template can be user-defined and/or auto-generated).

In one example embodiment, the updating operation further comprises obtaining corresponding meanings of new words of the input data set 236 based on the fused data set 232.

In one example embodiment, the processing the revised text pattern 424 further comprises fine-tuning the revised text pattern 424 to generate the fused data set 232.

In one example embodiment, the prompt encoder 308 is constructed and configured to construct the revised text pattern 424 according to new words in the input data set 236, the revised text pattern 424 enabling a pre-trained language model 312 to ascertain a specific meaning of the new words.

One or more embodiments can be used for many different applications, such as upgrading old machine learning methods or expert systems to better adapt to new requirements (e.g., those of an enterprise). In addition to enterprise systems, applications could include speech recognition, health assessment including administration of medicines based on same; planning missions of autonomous vehicles/controlling same; debugging code; controlling environmental spills; and the like. For example, send control signals over a WAN 102.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 200 which can include, for example, elements such as prompt encoder 308 and textGAN 316. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, the method comprising:
performing, using a prompt encoder, prompt learning on an input data set to generate a revised text pattern;
processing, using a text generative adversarial network, the revised text pattern based on an existing data set to generate a fused data set; and
updating a machine learning system with the fused data set.

2. The method of claim 1, wherein the performing and processing operations further comprise preserving an original meaning of the input data set while utilizing a style of the existing data set.

3. The method of claim 1, wherein the performance of the prompt learning matches the input data set with the existing data set using a user-defined or auto-generated template.

4. The method of claim 1, wherein the updating operation further comprises obtaining corresponding meanings of new words of the input data set based on the fused data set.

5. The method of claim 1, wherein the processing the revised text pattern further comprises fine-tuning the revised text pattern to generate the fused data set.

6. The method of claim 1, further comprising constructing the prompt encoder and configuring the prompt encoder to construct the revised text pattern according to new words in the input data set, the revised text pattern enabling a pre-trained language model to ascertain a specific meaning of the new words.

7. The method of claim 1, wherein the performing, processing, and updating steps are carried out without feature engineering by a human expert.

8. A non-transitory computer readable medium comprising computer executable instructions which when executed by a computer cause the computer to perform the method of:
performing, using a prompt encoder, prompt learning on an input data set to generate a revised text pattern;
processing, using a text generative adversarial network, the revised text pattern based on an existing data set to generate a fused data set; and
updating a machine learning system with the fused data set.

9. The non-transitory computer readable medium of claim 8, wherein, in the method caused to be performed by the instructions, the performing and processing operations further comprise preserving an original meaning of the input data set while utilizing a style of the existing data set.

10. The non-transitory computer readable medium of claim 8, wherein in the method caused to be performed by the instructions, the performance of the prompt learning matches the input data set with the existing data set using a user-defined or auto-generated template.

11. The non-transitory computer readable medium of claim 8, wherein in the method caused to be performed by the instructions, the updating operation further comprises obtaining corresponding meanings of new words of the input data set based on the fused data set.

12. The non-transitory computer readable medium of claim 8, wherein in the method caused to be performed by the instructions, the processing the revised text pattern further comprises fine-tuning the revised text pattern to generate the fused data set.

13. The non-transitory computer readable medium of claim 8, wherein the method caused to be performed by the instructions further comprises constructing the prompt encoder and configuring the prompt encoder to construct the revised text pattern according to new words in the input data set, the revised text pattern enabling a pre-trained language model to ascertain a specific meaning of the new words.

14. The non-transitory computer readable medium of claim 8, wherein, in the method caused to be performed by the instructions, the instructions are configured such that the performing, processing, and updating steps are carried out without feature engineering by a human expert.

15. An apparatus comprising:
a memory; and
at least one processor, coupled to said memory, and operative to perform operations comprising:
instantiating a prompt encoder, a text generative adversarial network, and a machine learning system;
performing, using the prompt encoder, prompt learning on an input data set to generate a revised text pattern;
processing, using the text generative adversarial network, the revised text pattern based on an existing data set to generate a fused data set; and
updating the machine learning system with the fused data set.

16. The apparatus of claim 15, wherein, in the operations performed by the at least one processor, the performing and processing operations further comprise preserving an original meaning of the input data set while utilizing a style of the existing data set.

17. The apparatus of claim 15, wherein, in the operations performed by the at least one processor, the performance of the prompt learning matches the input data set with the existing data set using a user-defined or auto-generated template.

18. The apparatus of claim 15, wherein, in the operations performed by the at least one processor, the updating operation further comprises obtaining corresponding meanings of new words of the input data set based on the fused data set.

19. The apparatus of claim 15, wherein, in the operations performed by the at least one processor, the processing the revised text pattern further comprises fine-tuning the revised text pattern to generate the fused data set.

20. The apparatus of claim 15, wherein, in the operations performed by the at least one processor, instantiating the prompt encoder comprises constructing the prompt encoder and configuring the prompt encoder to construct the revised text pattern according to new words in the input data set, the revised text pattern enabling a pre-trained language model to ascertain a specific meaning of the new words.
